(19) United States
(12) Patent Application Publication
(10) Pub. No.: US 2005/0201550 A1
(43) Pub. Date: Sep. 15, 2005

(54) Closeable radio communications device providing an acousitic chamber

(76) Inventors: YuRi Yang, Daegu (KR); HyunWoo Choi, Kyungki (KR)

Correspondence Address: MOTOROLA INC, 600 NORTH US HIGHWAY 45, ROOM AS437, LIBERTYVILLE, IL, 60048-5343, US

(21) Appl. No.: 10/797,326

(22) Filed: Mar. 10, 2004

(51) Int. Cl. H04M 1/00; H04M 9/00

(52) U.S. Cl. 379/433.02

(57) ABSTRACT

The invention provides for a closeable radio communications device (1) comprising a housing (21) having at two portions (22,23) pivotally mounted to each other to allow relative movement of the portions between a closed position and an opened position. There is a spacing projection (30) on one of the two portions (22,23), the spacing projection (30) being configured such that when the housing (21) is in the closed position an acoustic chamber (31) is formed by an inner surface (32) of the projection and facing surfaces (27,28) of the respective portions (22,23). A speaker (5d) mounted inside the housing (21) is in operative communication with the acoustic chamber (31).

### FIELD OF THE INVENTION

This invention relates to a closeable communications device with a two-part housing movable from a closed to an opened position. When in the closed position, the device provides an acoustic chamber for enhancing an audio signal's low frequency acoustic properties, the signal being emitted from a speaker typically mounted in the device. The invention is particularly useful for communications devices that have a two-part housing movable about a pivotal axis.

### BACKGROUND OF THE INVENTION

Communication devices, such as radio or cellular (mobile) telephones, that are easy to transport and support many features and functions are becoming commonplace. One communication device that is easy to transport is a closeable (or foldable) cellular telephone having a two part housing movable from an opened position to a closed position and vice versa. In the opened position, a conventional cellular telephone user interface includes a communications speaker, a microphone, a display and a keypad all of which are operable and accessible to a user. Also, in the opened position, the cellular telephone has a length that is sufficient to allow the ear and mouth of the user to align respectively with the speaker and microphone. In contrast, in the closed position some parts or all of the user interface may not be accessible to a user and the cellular telephone is shorter in length. It is therefore relatively easy for a user to store the telephone in a convenient place such a pocket, bag, purse or holster.

The features and functions desired by users of cellular telephones continue to increase whilst the size requirement trend is towards smaller more compact devices. The cellular telephone features and functions desired by users include camera features, video streaming capability, internet access, polyphonic alerts or ring-tones, integrated hands-free functions and improved audio output from both the communications speaker, used during telephone conversations, and an alert speaker/transducer.

Integrated hands-free communications devices including cellular telephones require a significant improvement in speaker quality compared with the earphone speaker arrangement provided in conventional cellular telephones. Furthermore, improvements in audio quality is required as telephone speakers are increasingly used for providing polyphonic ring-tones, playing music files, providing enhancement to games and providing hi fidelity audio from FM radio signals.

For a given speaker, audio quality can be improved by using an associated acoustic or audio cavity that is in audio communication with the given speaker. If a communications device has a separate communications speaker and alert speaker/transducer, then a common acoustic cavity can be used to save space. However, such cavities occupy valuable space within the body of the device that is contrary to the current size requirement trend towards smaller more compact devices.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a closeable radio communications device comprising: a housing having at least two portions movably mounted to each other to allow relative movement of the portions between a closed position and an opened position; at least one spacing projection on at least one of the two portions, the spacing projection being configured such that when the housing is in the closed position an acoustic chamber is formed by at least an inner surface of the projection and facing surfaces of the respective portions; and a speaker in operative communication with the acoustic chamber.

Suitably, the projection provides an enclosing wall for both facing surfaces when the housing is in the closed position. Preferably, the projection forms continuous rim. Suitably, the projection has resilient properties.

Preferably, there is at least one aperture in communication with the chamber for allowing audible signals to be emitted from the chamber to an outside the housing.

At least one of the facing surfaces may have a chamber exit aperture therein for allowing audible signals to be emitted from the chamber and outside of the housing. There may also be a further aperture in communication with the chamber exit aperture through a void in one of the portions.

Preferably, the projection has at least one aperture therein for allowing audible signals to be emitted from the chamber to an outside of the housing.

In one suitable embodiment, the closeable radio communications device may include a housing position detector coupled to a processor mounted in the housing. Preferably, the processor may provide volume control for the speaker to increase the audio signal output of the speaker when the portions are in the closed position and reduced the audio signal output of the speaker when the portions are in the opened position.

Suitably, the two portions are pivotally mounted to each other. Preferably, the speaker is an alert speaker for providing an alert associated with an incoming call.

According to another aspect of the invention there is provided a closeable radio communications device comprising: a housing having at least two portions movably mounted to each other to allow relative movement of the portions between a closed position and an opened position; at least one spacing projection on at least one of the two portions, the spacing projection being configured such that when the housing is in the closed position the projection is sandwiched between facing surfaces of the respective portions an acoustic chamber is formed by at least an inner surface of the projection and facing surfaces of the respective portions ; and a speaker in operative communication with the acoustic chamber.

Suitably, the projection provides an enclosing wall for both facing surfaces when the housing is in the closed position.

Preferably, the projection forms continuous rim. Suitably, the projection has resilient properties.

In one preferred embodiment, there is a projection fixed to each of the facing surfaces. Suitably, the projection is a flange. Preferably, the projection has at least one aperture therein for allowing audible signals to be emitted from the chamber to an outside of the housing.

In one suitable preferred emdodiment, the closeable radio communications device includes a housing position detector coupled to a processor mounted in the housing.

Preferably, the processor may provide volume control for the speaker to increase the audio signal output of the speaker when the portions are in the closed position and reduced the audio signal output of the speaker when the portions are in the opened position.

Suitably, the two portions are pivotally mounted to each other. Preferably, in one suitable form the speaker is an alert speaker for providing an alert associated with an incoming call.

### BRIEF DESCRIPTION OF THE DRAWINGS

In order that the invention may be readily understood and put into practical effect, reference will now be made to preferred embodiments as illustrated with reference to the accompanying drawings in which:

FIG. 1 is a block diagram illustrating circuitry of a closeable radio communications device in accordance with the invention;

FIG. 2 illustrates a first embodiment of the closeable radio communications device of FIG. 1 when in a closed position;

FIG. 3 illustrates the first embodiment of the closeable radio communications device of FIG. 1 when in an opened position;

FIG. 4 illustrates a cross sectional view through 4-4 of part of the closeable radio communications device FIG. 2;

FIG. 5 illustrates a second embodiment of the closeable radio communications device of FIG. 1 when in a closed position;

FIG. 6 illustrates the second embodiment of the closeable radio communications device of FIG. 1 when in an opened position; and

FIG. 7 illustrates a cross sectional view through 7-7 of part of the closeable radio communications device FIG. 5.

### DETAILED DESCRIPTION OF THE PREFERRED EMBODIMENT OF THE INVENTION

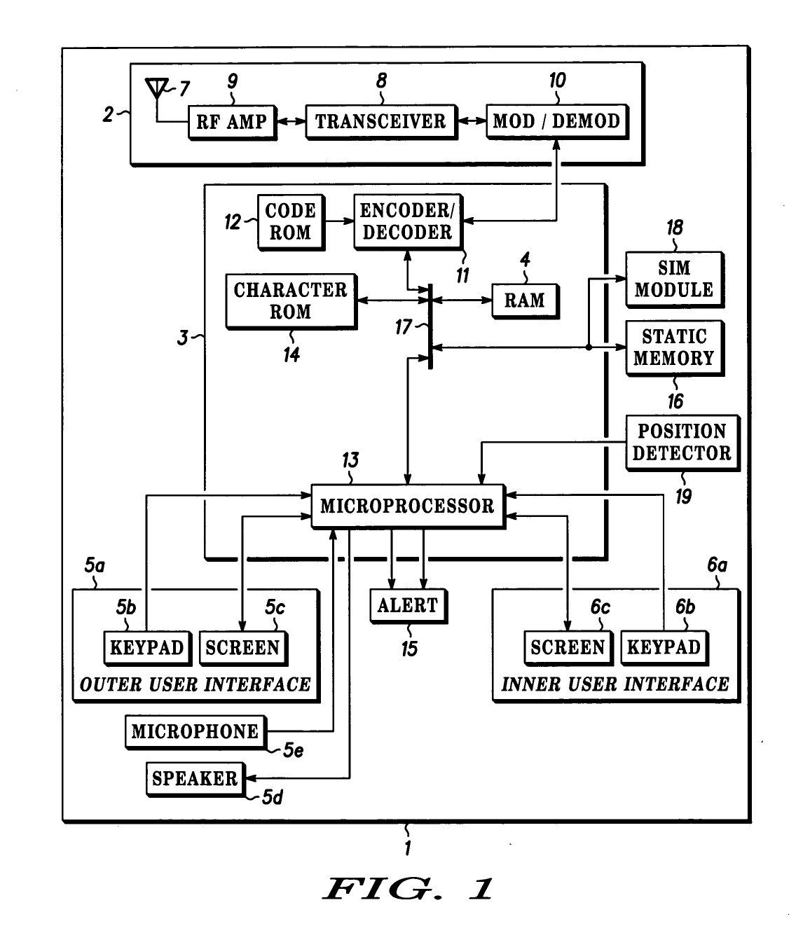

In the drawings, like numerals on different Figs are used to indicate like elements throughout. With reference to FIG. 1, there is illustrated an closeable radio communications device 1 comprising a radio frequency communications unit 2 coupled to be in communication with a processor 3. The device 1 also has an outer user interface 5a with a screen 5c and a keypad 5b and an inner user interface 6a with a screen 6c and a keypad 6b. The respective screens 5c, 6c and keypads 5b, 6b of interfaces 5a, 6a are coupled to be in communication with the processor 3. Also, as will be apparent to a person skilled in the art, screens 5c, 6c may be touch screens thereby making the keypads 5b, 6b optional. A housing position detector 19 is also coupled to the processor 3 to provide a housing position signal (PS), the position detector 19 typically being a mechanically actuated push button switch, however, the position detector 19 can comprise any suitable detector such as a magnetic sensor (reed switch), a capacitance sensor, an inductance sensors, a potentiometer or a photo sensor.

The processor 3 includes an encoder/decoder 11 with an associated Read Only Memory (ROM) 12 storing data for encoding and decoding voice or other signals that may be transmitted or received by the device 1. The processor 3 also includes a micro-processor 13 coupled, by a common data and address bus 17, to the encoder/decoder 11, a character Read Only Memory (ROM) 14, a Random Access Memory (RAM) 4, static programmable memory 16 and a removable SIM module 18. The static programmable memory 16 and SIM module 18 each can store, amongst other things, selected incoming text messages and a Telephone Number Database TND (phonebook) comprising a number field for telephone numbers and name field for identifiers associated with one the numbers in the name field. For instance, one entry in the Telephone Number Database TND may be 91999111111(entered in the number field) with an associated identifier “Steven C at work” in the name field.

The micro-processor 13 has ports for coupling to the interfaces 5a, 6a and an alert module 15 that typically contains an alert speaker, vibrator motor and associated drivers. Also, micro-processor 13 has ports for coupling to a microphone 5e communications speaker 5d. The character Read only memory 14 stores code for decoding or encoding text messages that may be received by the communication unit 2. In this embodiment the character Read Only Memory 14 also stores operating code (OC) for micro-processor 13 and code for performing functions associated with the device 1.

The radio frequency communications unit 2 is a combined receiver and transmitter having a common antenna 7. The communications unit 2 has a transceiver 8 coupled to antenna 7 via a radio frequency amplifier 9. The transceiver 8 is also coupled to a combined modulator/demodulator 10 that couples the communications unit 2 to the processor 3.

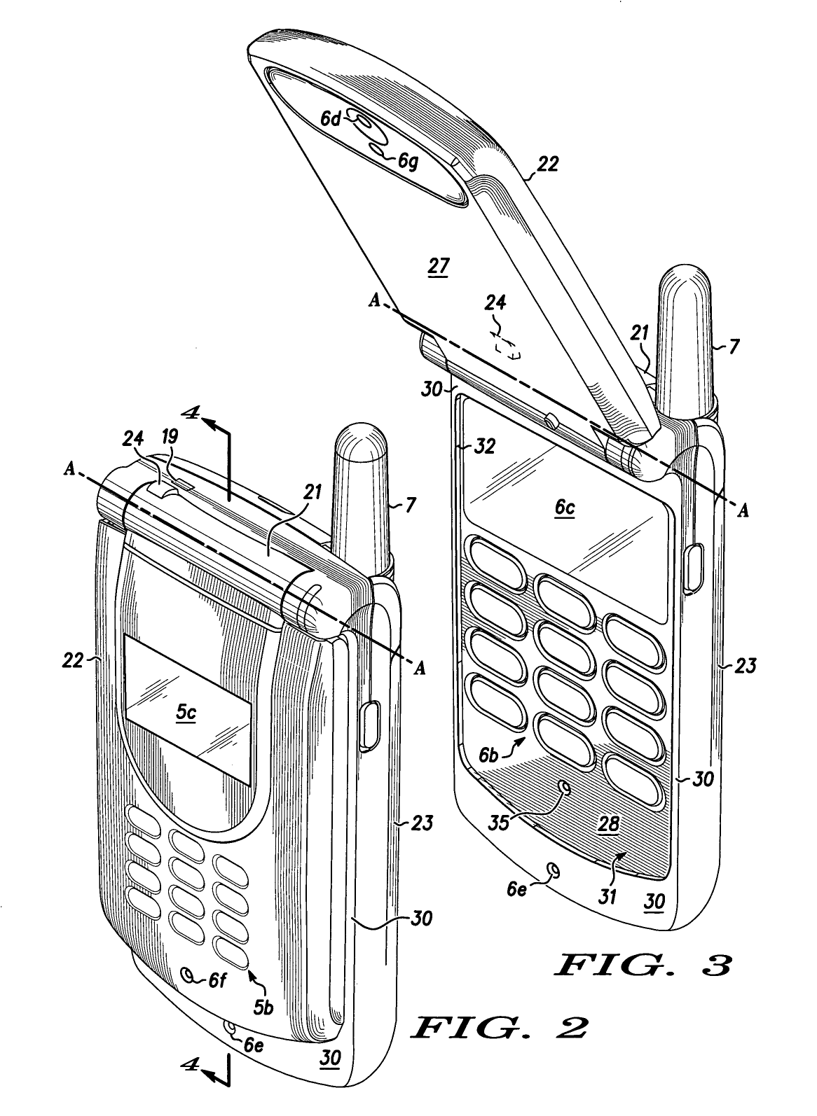

Referring to FIGS. 2 and 3 there is illustrated a first embodiment of the closeable (foldable) radio communications device 1 in the form of a radio telephone often referred to as a mobile or cellular telephone. The closeable radio communications device 1 has a housing 21 with two portions 22, 23 movably mounted to each other to allow relative movement of the portions 22,23 between a closed position of FIG. 2 and an opened position of FIG. 3. Disposed, or partially disposed, in the housing 21 are the components of FIG. 1 including the transceiver 8 and processor 3.

The relative movement, as shown in this embodiment, is achieved by the portions 22,23 being pivotally mounted to each other about a pivotal axis A. In the closed position of FIG. 2 the outer user interface 5a of the screen 5c and the keypad 5b are visible and accessible by a user, the screen 5c and a keypad 5b being disposed in portion 22. Also, the microphone 5e and communications speaker 5d are audibly accessible and operable when the housing 21 is in the closed position (as described below). In contrast, the inner user interface 6a of the screen 6c and the keypad 6b, disposed in portion 23, are totally hidden and inoperable (sandwiched between portions 22,23) when the housing 21 is in the closed position.

As clearly shown in FIG. 2, the closeable radio communications device 1 has a protrusion 24, on the housing 21, for co-acting with the housing position detector 19 to generate the position signal (PS) indicative of the housing 21 being in the opened position when the housing 21 is moved from the closed to the opened position. Shown in the opened position of FIG. 3 is the inner user interface 6a of the screen 6c and the keypad 6b that are accessible, visible and operable. When in the closed position the portions 22, 23 have respective facing surfaces 27,28 that face each other and are spaced apart by a spacing projection 30 located on portion 23. The spacing projection 30 is configured such that when the housing 21 is in the closed position an acoustic chamber 31 is formed that is defined by at least an inner surface 32 of the projection 30 and facing surfaces 27,28.

The microphone 5e is mounted in one of the two portions 23 and it is audibly accessible via a microphone aperture 6e. The communications speaker 5d is mounted in the other one of the two portions 22 and is audibly accessible directly via a speaker aperture 6d when the housing 21 is in the opened position and via the speaker aperture 6d, chamber 31 and two associated chamber exit apertures 6g, 6f when in the closed position (described below). Also, the alert module 15 is audibly accessible via an alert aperture 35, chamber 31 and the two associated chamber exit apertures 6g, 6f when the housing is in the closed position (described below).

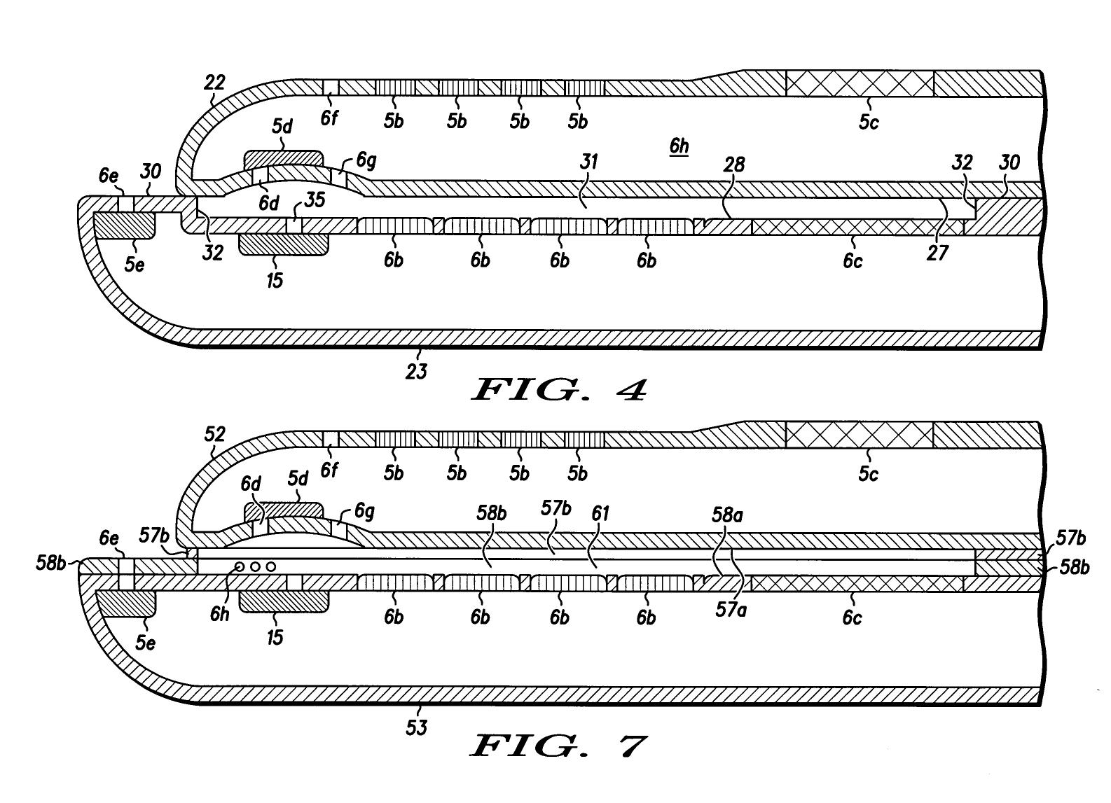

Referring to FIG. 4 there is illustrated a cross sectional view of the closeable communications device 1 when in the closed position. For clarity, in the illustration of FIG. 4 most of the electronic circuitry and components have been removed as will be apparent to a person skilled in the art. The spacing projection 30 is integrally moulded into portion 23 and provides an enclosing wall for both facing surfaces 27,28 when the housing 21 is in the closed position. More specifically, the spacing projection 30 provides a continuous rim and the spacing projection 30 may be an integrally moulded plastics projection extending from portion 23. However, in one alternative form the spacing projection 30 may be a resilient rubber flange insert moulded into portion 23 thereby providing spacing projection 30 with resilient properties.

The spacing projection 30 is configured to form the continuous rim such that when the housing 21 is in the closed position the continuous rim and the facing surfaces 27,28 form the acoustic chamber 31 defined by the inner surface 32 of the spacing projection 30 (continuous rim) and facing surfaces 27,28 that includes the inner user interface 6a.

The communications speaker 5d and alert module 15 are in operative communication with the acoustic chamber 31. As briefly mentioned above, the communications speaker 5d is audibly accessible via the speaker aperture 6d, chamber 31 and the two associated chamber exit apertures 6g, 6f. In this regard, during operation of the communications speaker 5d audible signals are emitted through the speaker aperture 6d and into the chamber 31. The chamber 31 provides improved low frequency acoustic properties of the audible signals that are then emitted out of the chamber 31 through aperture 6g, in facing surface 27, into a void 6h in portion 22 and then out of the housing 21 to a user through aperture 6f. Similarly, as also briefly mentioned above, the alert module 15 that typically comprises a polyphonic speaker is audibly accessible via the alert aperture 35, chamber 31 and the two associated apertures, these being a chamber exit aperture 6g and a further aperture 6f that are in communication with each other through the void 6h. During operation of the alert module 15 audible signals (typically polyphonic ring-tones) are emitted through the alert aperture 35 and into the chamber 31. Again, the chamber 31 provides improved low frequency acoustic properties of the audible signals that are then emitted out of the chamber 31 through aperture 6g into the void 6h in portion 22 and then outside of housing 21 to a user through aperture 6f.

In use, when the housing 21 is in the closed position the communications speaker 5d and polyphonic speaker of the alert module 15 are in operative communication with the acoustic chamber. If there is an incoming call polyphonic ring-tones from the alert module 15 enter the chamber 31 and improved low frequency acoustic properties are emitted to a user via chamber exit aperture 6g, and further aperture 6f that are in communication with each other through the void 6h. Also, a user can initiate an outgoing communication call through the transceiver 8 by selecting one or more functions selectable at the outer user interface 5a. In addition during the communication call, when the housing is in the closed position, the communications speaker 5d and microphone 5e are operable. In this regard, the communications speaker 5d and microphone 5e may operate as a hands-free speakerphone in which a user may place the device 1 on a table or desk whilst communicating in the call via the communications speaker 5d and microphone 5e. During operation of the device 1 as a hands-free speakerphone, audible signals are emitted from the communications speaker enter the chamber 31 and improved low frequency acoustic properties are emitted to a user via apertures 6g, 6f that are in communication with each other through the void 6h.

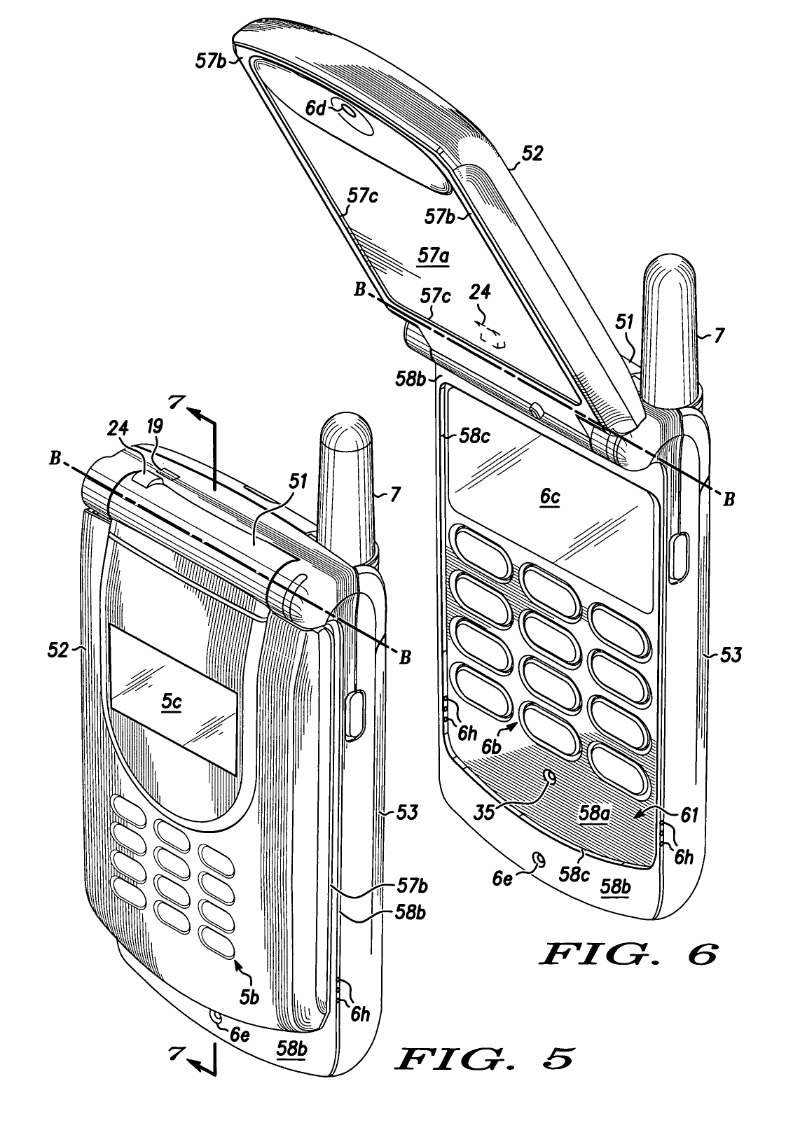

Referring to FIGS. 5 and 6 there is illustrated a second embodiment of the closeable radio communications device in the form of a radio telephone. The closeable radio communications device has a housing 51 with two portions 52, 53 movably mounted to each other to allow relative movement of the portions 52,53 between a closed position of FIG. 5 and an opened position of FIG. 6. Disposed, or partially disposed, in the housing 51 are the components of FIG. 1 including the transceiver 8 and processor 3.

The relative movement, is achieved by the portions 52,53 being pivotally mounted to each other about a pivotal axis B. In the closed position of FIG. 5 the outer user interface 5a of the screen 5c and the keypad 5b are visible and accessible by a user, the screen 5c and a keypad 5b being disposed in portion 52. Also, the microphone 5e and communications speaker 5d are audibly accessible and operable when the housing 51 is in the closed position (as described below). In contrast, the inner user interface 6a of the screen 6c and the keypad 6b, disposed in portion 53, are totally hidden and inoperable(sandwiched between portions 52,53) when the housing 51 is in the closed position. The inner user interface 6a of the screen 6c and the keypad 6b are accessible, visible and operable when the closeable radio communications device in the opened position.

When in the closed position the portions 52,53 have respective facing surfaces 57a, 58a with respective spacing flanges 57b, 58b providing two projections. The flanges 57b, 58b are formed from resilient rubber material that is fixed to their respective facing surfaces 57a, 58a. The flanges 57b, 58b provide the spacing projections configured such that when the housing 51 is in the closed position, the flanges 57b, 58b are aligned and abut each other. As a result, the spacing projections and the facing surfaces 57a, 58a form an acoustic chamber 61 defined by at least respective inner surfaces 57c, 58c of the flanges 57b, 58b that are sandwiched between the facing surfaces 57a, 58a.

The microphone 5e is mounted in one of the two portions 53 and it is audibly accessible via a microphone aperture 6e. The communications speaker 5d is mounted in the other one of the two portions 52 and is audibly accessible directly via the speaker aperture 6d when the housing 51 is in the opened position and via the speaker aperture 6d, chamber 61 a chamber exit apertures 6h in the flange 58b when in the closed position. Also, the alert module 15 is audibly accessible via an alert aperture 35, chamber 51 and the exit apertures 6h when the housing 51 is in the closed position.

Referring to FIG. 7 there is illustrated a cross sectional view of the closeable communications device when in the closed position. Again, for clarity, most of the electronic circuitry and components have been removed. The flanges 57b, 58b are configured to form a continuous rim such that when the housing 51 is in the closed position the inner surfaces 57c, 58c and the facing surfaces 57a, 58a form the acoustic chamber 61. The communications speaker 5d and alert module 15 are in operative communication with the acoustic chamber 61. This chamber 61 provides the same functions as described above with reference to the first embodiment of the invention and the resilient properties of the flanges operate in a similar manner to gaskets thereby providing an improved chamber seal for the chamber 61 as compared with non-resilient flanges

Advantageously, the present invention provides for allowing a relatively compact communications device that has an acoustic cavity that does not necessarily occupy valuable space inside the device's housing. The present invention may suitably provide improved low frequency acoustics to the user for signals emitted from the communications speaker 5d or improved low frequency polyphonic ring-tones or other alert tones generated from the alert module 15. Also, the processor 3 may provide volume control of the communications speaker 5d to increase its audio signal output when the portions are in the closed position, indicated by the position signal (PS), to thereby provide a increased volume when in speakerphone mode. Also, a reduced audio signal output of the communications speaker 5d is provided when the portions are in the opened position as indicated by the position signal (PS).

The detailed description provides preferred exemplary embodiments only, and is not intended to limit the scope, applicability, or configuration of the invention. Rather, the detailed description of the preferred exemplary embodiments provides those skilled in the art with an enabling description for implementing preferred exemplary embodiments of the invention. It should be understood that various changes may be made in the function and arrangement of elements without departing from the spirit and scope of the invention as set forth in the appended claims. For instance, although a clamshell type device has been illustrated, other closeable devices may be used such as flip telephones or other types of rotatable two part telephones a typical example of which is the Motorola® V70™ cellphone.

1. A closeable radio communications device comprising:
a housing having at least two portions movably mounted to each other to allow relative movement of the portions between a closed position and an opened position;
at least one spacing projection on at least one of the two portions, the spacing projection being configured such that when the housing is in the closed position an acoustic chamber is formed by at least an inner surface of the projection and facing surfaces of the respective portions; and
a speaker in operative communication with the acoustic chamber.

2. A closeable radio communications device as claimed in claim 1, wherein the projection provides an enclosing wall for both facing surfaces when the housing is in the closed position.

3. A closeable radio communications device as claimed in claim 1, wherein the projection forms continuous rim.

4. A closeable radio communications device as claimed in claim 1, wherein the projection has resilient properties.

5. A closeable radio communications device as claimed in claim 1, wherein there is at least one aperture in communication with the chamber for allowing audible signals to be emitted from the chamber to an outside the housing.

6. A closeable radio communications device as claimed in claim 5, wherein least one of the facing surfaces has a chamber exit aperture therein for allowing audible signals to be emitted from the chamber and outside of the housing.

7. A closeable radio communications device as claimed in claim 6, wherein there is a further aperture in communication with the chamber exit aperture through a void in one of the portions.

8. A closeable radio communications device as claimed in claim l, wherein the projection has at least one aperture therein for allowing audible signals to be emitted from the chamber to an outside of the housing.

9. A closeable radio communications device as claimed in claim 1, wherein the closeable radio communications device includes a housing position detector coupled to a processor mounted in the housing.

10. A closeable radio communications device as claimed in claim 1, wherein the processor provides volume control for the speaker to increase the audio signal output of the speaker when the portions are in the closed position and reduced the audio signal output of the speaker when the portions are in the opened position.

11. A closeable radio communications device as claimed in claim 1, wherein the two portions are pivotally mounted to each other.

12. A closeable radio communications device as claimed in claim 1, wherein the speaker is an alert speaker for providing an alert associated with an incoming call.

13. A closeable radio communications device comprising:
a housing having at least two portions movably mounted to each other to allow relative movement of the portions between a closed position and an opened position;
at least one spacing projection on at least one of the two portions, the spacing projection being configured such that when the housing is in the closed position the projection is sandwiched between facing surfaces of the respective portions an acoustic chamber is formed by at least an inner surface of the projection and facing surfaces of the respective portions ; and
a speaker in operative communication with the acoustic chamber.

14. A closeable radio communications device as claimed in claim 13, wherein the projection provides an enclosing wall for both facing surfaces when the housing is in the closed position.

15. A closeable radio communications device as claimed in claim 13, wherein the projection forms continuous rim.

16. A closeable radio communications device as claimed in claim 13, wherein the projection has resilient properties.

17. A closeable radio communications device as claimed in claim 13, wherein there is a said projection fixed to each of the facing surfaces.

18. A closeable radio communications device as claimed in claim 17, wherein the projection is a flange.

19. A closeable radio communications device as claimed in claim 13, wherein the projection has at least one aperture therein for allowing audible signals to be emitted from the chamber to an outside of the housing.

20. A closeable radio communications device as claimed in claim 13, wherein the closeable radio communications device includes a housing position detector coupled to a processor mounted in the housing.

21. A closeable radio communications device as claimed in claim 20, wherein the processor provides volume control for the speaker to increase the audio signal output of the speaker when the portions are in the closed position and reduced the audio signal output of the speaker when the portions are in the opened position.

22. A closeable radio communications device as claimed in claim 13, wherein the two portions are pivotally mounted to each other.

23. A closeable radio communications device as claimed in claim 13, wherein the speaker is an alert speaker for providing an alert associated with an incoming call.
